(19) United States
(12) Patent Application Publication
(10) Pub. No.: US 2003/0131468 A1
(43) Pub. Date: Jul. 17, 2003

(54) Production apparatus

(75) Inventor: Kimihiko Yasuda, Anjo-shi (JP)

Correspondence Address: OLIFF & BERRIDGE, PLC, P.O. BOX 19928, ALEXANDRIA, VA, 22320, US

(73) Assignee: FUJI MACHINE MFG. CO., LTD., Chiryu-shi (JP)

(21) Appl. No.: 10/330,271

(22) Filed: Dec. 30, 2002

(30) Foreign Application Priority Data
Jan. 16, 2002 (JP) 2002-008025

(51) Int. Cl. B23P 19/00; G06F 19/00

(52) U.S. Cl. 29/739; 29/840; 700/95

(57) ABSTRACT

A production apparatus including an operating device, a control device which controls an operation of the operating device, a communication-terminal interface through which the control device is connectable to a communication terminal, and a memory in which a communication software needed for communication between the control device and the communication terminal through the communication-terminal interface is stored.

### BACKGROUND OF THE INVENTION

1. Field of the Invention

The present invention relates to the art of informing an external device of a condition of a production apparatus, or the art of checking, through an external device, a condition of a production apparatus.

2. Discussion of Related Art

Usually, services are made after a production apparatus is disposed in a factory; such as checking of the apparatus, treating of troubles occurring to the apparatus, or updating of software used in the apparatus. When those services are made, information related to the production apparatus is obtained, and information is inputted in the apparatus. However, conventionally, such information has been treated such that the information is printed on a sheet of paper, or is recorded on a recording medium, such as a floppy disk or other sorts of magnetic recording media, that is removable from the apparatus.

However, the above-indicated, conventional information-treating method takes a long time till the information is received by a service making party such as a manufacturer or a dealer. Thus, in many cases, a service person goes to the factory and directly obtains, from the production apparatus, information related to the current condition of the apparatus. Hence, the service making party wants to make the services at a place remote from the factory, without directly going to the factory, so as to improve the efficiency of operation. For example, if the service person can recognize, at the remote place, the current condition of the production apparatus and control the apparatus as if the person directly operated a control device of the apparatus in the factory, the frequency at which the service person goes to the factory decreases, which leads to easily improving the efficiency of operation. Additionally, since necessary services are made without delay, the rate of operation of the production apparatus can be easily prevented from decreasing.

The above-indicated problem may be solved by communicating information between the control device of the production apparatus and a computer (e.g., a computer incorporated in a portable telephone) that can be used by the service person. For example, the control device of the production apparatus is directly connected to an external computer located outside the factory via a public communication line, or the control device of the apparatus is connected to an internet via a network (e.g., a local area network, LAN) located inside the factory. However, the first method has a problem that there may be no available public communication lines to which the control device can be directly connected, because no such communication lines are provided around the factory in which the production apparatus is disposed; and the second method has a problem that the user may refuse to connecting the production apparatus to the internet via the in-factory network.

### SUMMARY OF THE INVENTION

It is therefore an object of the present invention to improve the art of informing an external device of a condition of a production apparatus, or the art of checking, through an external device, a condition of a production apparatus. This object may be achieved according to any one of the following modes of the present invention in the form of a production apparatus, each of which is numbered like the appended claims and may depend from the other mode or modes, where appropriate, to indicate and clarify possible combinations of technical features. It is, however, to be understood that the present invention is not limited to the technical features or any combinations thereof that will be described below for illustrative purposes only. It is to be further understood that a plurality of features included in any one of the following modes of the invention are not necessarily provided altogether, and that the invention may be embodied without at least one of the features described with respect to the same mode.

(1) A production apparatus comprising:

an operating device;

a control device which controls an operation of the operating device;

a communication-terminal interface through which the control device is connectable to a communication terminal; and

a memory in which a communication software needed for communication between the control device and the communication terminal through the communication-terminal interface is stored.

According to this mode, the production apparatus is connectable to a communication terminal such as a portable telephone, a communication card, or other sorts of commercially available portable terminals, and accordingly the apparatus is connectable, wherever it may be disposed, to an external computer such as a host computer via the communication terminal. The communication terminal is a wireless-communication terminal that is connectable to a public communication line via a wireless-communication station. It is preferred that the communication terminal be a portable terminal. Though the portable terminal may be one owned by an operator of the production apparatus, it is preferred that the portable terminal be one used exclusively with the production apparatus, as will be described later.

The communication-terminal interface is in a fixed state in which the interface is connected to the control device, and a communication terminal is disconnectably connected to the interface by insertion of a connector of the terminal or operation of a switch. If a communication terminal is connected, as needed, to the communication-terminal interface, then the control device is made able to communicate via the communication terminal. On the other hand, if the control device does not communicate, then the communication terminal is disconnected from the communication-terminal interface so as to make the control device unable to communicate. Thus, the control device is easily prevented from inappropriate access thereto. Even in the case where there is a network in a factory in which the production apparatus is disposed, the production apparatus is directly connectable to the public communication line, without the help of the network. Thus, the production apparatus is not subjected to any restrictions provided for the security of the network. According to this mode, the communication terminal may, or may not, be a constitutional element of the production apparatus.

(2) A production apparatus comprising:

an operating device;

a control device which controls an operation of the operating device;

a connectable portion which is connectable to a communication terminal incorporating a communication-terminal interface; and

a memory in which a communication software needed for communication between the control device and the communication terminal through the communication-terminal interface is stored.

According to this mode, too, the communication terminal may, or may not, be a constitutional element of the production apparatus.

(3) A production apparatus comprising:

at least one operating device;

a control device which controls an operation of said at least one operating device;

a communication-terminal interface;

a communication terminal which is connectable to the control device through the communication-terminal interface; and

a memory in which a communication software needed for communication between the control device and the communication terminal through the communication-terminal interface is stored.

Generally, the memory is provided as a portion of the control device. However, this is not essentially required. For example, it is possible to employ a communication-related computer independent of the control device, and store the communication software in a ROM or a RAM of the computer. It is preferred that the communication-terminal interface be in a fixed state in which the interface is connected to the control device. However, it is possible to employ a communication-terminal interface that is disconnectably connectable to a connectable portion, such as a connector, that is provided as a portion of the control device. Though the communication terminal is connected to the control device via the communication-terminal interface, it is possible to employ a communication terminal that incorporates the communication-terminal interface. In addition, it is possible to employ a communication terminal that incorporates a computer including the memory in which the communication software is stored.

Since the production apparatus is directly connectable to the public communication line using the communication terminal, the production apparatus enjoys a certain degree of communication versatility irrespective of the place where the apparatus is disposed.

The production apparatus is easily switchable to a disconnected state in which the control device is disconnected from the communication terminal, and to a connected state in which the control device is connected to the communication terminal. However, the production apparatus may be one in which the communication terminal is in a fixed state in which the terminal is connected to the control device. In the former case, the production apparatus is switched, as needed, to the connected state in which the control device is connected to the communication terminal, so that the control device can transmit and receive information to and from a computer located at a remote place, and otherwise is switched to the disconnected state in which the control device is disconnected from the communication terminal, so that the control device is unable to communicate and is prevented from illegal access thereto.

The production apparatus may be switched to the connected state or the disconnected state, using a connector or a switch that is provided at a location, e.g., between the communication terminal and the communication-terminal interface, or between the interface and a connectable portion of the control device, where the connector or the switch is easily operable.

(4) An apparatus according to the mode (3), wherein the communication-terminal interface is in a fixed state in which the interface is connected to the control device, and the communication terminal is disconnectably connected to the interface.

This mode (4) may be combined with the mode (1) or (2).

(5) An apparatus according to the mode (3) or (4), wherein the communication terminal comprises a portable telephone.

Since a portable telephone that is widely spread is employed as the communication terminal, it is not needed to employ an exclusive communication device.

(6) An apparatus according to any of the modes (3) through (5), wherein the communication terminal comprises a communication card.

Since a communication card that has already been spread is employed as the communication terminal, a computer as an essential portion of the control device of the production apparatus can easily transmit and receive information to and from an external device.

(7) An apparatus according to any of the modes (1) through (6), wherein the control device comprises a switch which is selectively operable to a communication permitting position in which the control device is permitted to perform communication via the communication terminal, and a communication inhibiting position in which the control device is inhibited from performing communication.

As described above, the communication-terminal interface and the communication terminal may be connected to, and disconnected from, each other by inserting and removing a connector, respectively. According to this mode, however, the production apparatus is provided with the switch that is selectively operable to the communication permitting position and the communication inhibiting position. Thus, it is not needed to insert or remove the connector.

(8) An apparatus according to any of the modes (1) through (7), wherein the communication software comprises an operation-related information transmitting step of transmitting operation-related information that is related to the operation of said at least one operating device.

The operation-related information may comprise at least a portion of all the information that can be obtained from the production apparatus as a whole. Thus, the operation-related information may comprise an arbitrarily selected portion of the information that can be obtained by the control device from the production apparatus.

(9) An apparatus according to the mode (8), wherein the operation-related information comprises a rate of operation of said at least one operating device.

(10) An apparatus according to the mode (8) or (9), further comprising a display device which displays information representing at least one operating condition of said at least one operating device, and the operation-related information comprises the information displayed by the display device.

The phrase “at least one operating condition of the operating device” should be construed to encompass not only an operation condition in its narrow meaning, such as stopping of the operating device because of malfunction; displaying of consumption of components; displaying of details of the device malfunction or the component consumption; or a degree of advancing of the operation, but also an operation condition in its wide meaning, such as displaying of a request or an instruction directed to the operator to perform a certain operation or treatment. The request or instruction directed to the operator can be regarded as an indication that the operating device is in such an operating condition thereof.

(11) An apparatus according to any of the modes (1) through (10), wherein the communication software comprises an information receiving step of receiving information which is supplied via a public communication line.

(12) An apparatus according to the mode (11), further comprising a display device which displays each one of a plurality of images representing a plurality of operating conditions of said at least one operating device, and the information receiving step comprises an image-change-command receiving step of receiving an image-change command to command the display device to change said each one of the images to another image.

(13) An apparatus according to the mode (11) or (12), wherein the information receiving step comprises a remote-control-signal receiving step of receiving a remote-control signal for remote control of the apparatus.

The remote control of the production apparatus enables a service person at a place remote from the operating device to operate the operating device as if the person went to the place where the operating device is disposed. For example, the service person is allowed to check the operating device, treat or shoot a trouble occurring to the operating device, or update software used with the operating device. However, it is preferred that during an operation of the production apparatus, a remote-control signal related to the operation be not received for preventing the control device from confusing with respect to the control of the operation.

(14) An apparatus according to any of the modes (1) through (13), comprising an operation-on-circuit-substrate performing apparatus, wherein said at least one operating device comprises an operation-on-circuit-substrate performing device which performs an operation on a circuit substrate.

(15) An apparatus according to the mode (14), comprising an electric-component mounting apparatus, wherein the operation-on-circuit-substrate performing device comprises an electric-component mounting device which mounts at least one electric component on the circuit substrate.

Usually, the electric-component mounting apparatus includes, in addition to the electric-component mounting device, an electric-component supplying device that supplies electric components to the mounting device; and a circuit-substrate supporting device that supports a circuit substrate on which the electric components are mounted by the mounting device. Usually, the electric-component mounting device includes a holder head that holds an electric component; and a moving device that moves at least one of the holder head and the circuit-substrate supporting device relative to the other of the head and the supporting device in directions parallel to a surface of the circuit substrate supported by the supporting device.

(16) An apparatus according to the mode (14) or (15), comprising a screen-printing apparatus, wherein the operation-on-circuit-substrate performing device comprises a screen-printing device which screen-prints a high-viscosity fluid, such as a cream solder, on the circuit substrate.

Usually, the screen-printing apparatus includes, in addition to the screen-printing device, a circuit-substrate supporting device that supports the circuit substrate. Usually, the screen-printing device includes a screen holding device that holds a screen having a plurality of through-holes at respective prescribed positions; and a squeegee device that is moved on the screen held by the screen holding device so as to print a high-viscosity fluid on the circuit substrate supported by the circuit-substrate supporting device.

(17) An apparatus according to any of the modes (14) through (16), comprising a high-viscosity-fluid applying apparatus, wherein the operation-on-circuit-substrate performing device comprises a high-viscosity-fluid applying device which applies a high-viscosity fluid in form of spots to the circuit substrate.

Usually, the high-viscosity-fluid applying apparatus includes, in addition to the high-viscosity-fluid applying device, a circuit-substrate supporting device that supports the circuit substrate. Usually, the high-viscosity-fluid applying device includes an applying head including a spouting nozzle for spouting the high-viscosity fluid; and an applying-head moving device that moves the applying head in at least directions parallel to a surface of the circuit substrate supported by the supporting device.

(18) An apparatus according to any of the modes (1) through (17), wherein the control device comprises a control computer which controls the operation of the operating device.

(19) An apparatus according to the mode (18), further comprising a host computer which is connected to the control computer and supplies, to the control computer, information needed to control the operation of the operating device.

(20) An apparatus according to the mode (19), wherein the communication-terminal interface is connected to the host computer.

(21) A communication method comprising the steps of:

connecting a production apparatus including an operating device and a control device which controls the operating device, to a public communication line via a communication terminal,

transmitting, and receiving, information related to the production apparatus, to, and from, the public communication line via the communication terminal, respectively, and

authorizing an operator of the production apparatus to permit communication between the production apparatus and the public communication line via the communication terminal.

The present method may employ any of the above-indicated modes (1) to (20).

### BRIEF DESCRIPTION OF THE DRAWINGS

The above and optional objects, features, and advantages of the present invention will be better understood by reading the following detailed description of the preferred embodiments of the invention when considered in conjunction with the accompanying drawings, in which:

FIG. 1 is a plan view of an electronic-component mounting apparatus as an embodiment of the present invention;

FIG. 2 is an enlarged, cross-sectioned, side elevation view of a portion of the mounting apparatus of FIG. 1;

FIG. 3 is a block diagram for explaining a construction of a control device of the mounting apparatus;

FIG. 4 is a block diagram for explaining a communication function of the control device of FIG. 3;

FIG. 5 is a view for explaining information related to the mounting apparatus;

FIG. 6 is a block diagram for explaining a communication function of another control device that may be used with the mounting apparatus;

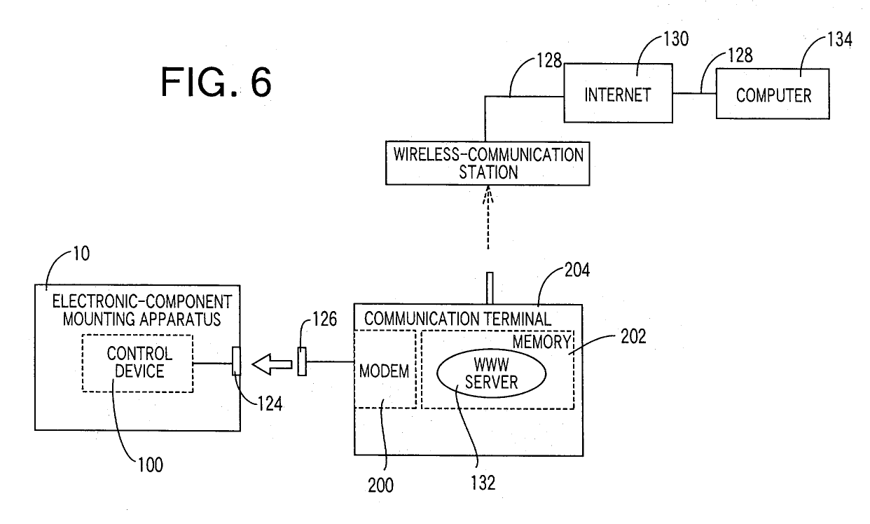

FIG. 7 is a plan view of an inspecting apparatus as another embodiment of the present invention;

FIG. 8 is a plan view of an adhesive applying apparatus as another embodiment of the present invention;

FIG. 9 is a partly cross-sectioned, side elevation view of a portion of the adhesive applying apparatus of FIG. 8;

FIG. 10 is a front elevation view of a mask-printing apparatus as another embodiment of feeder;

FIG. 11 is a side elevation view of the mask-printing apparatus of FIG. 9; and

FIG. 12 is a plan view of the mask-printing apparatus.

### DETAILED DESCRIPTION OF THE PREFERRED EMBODIMENTS

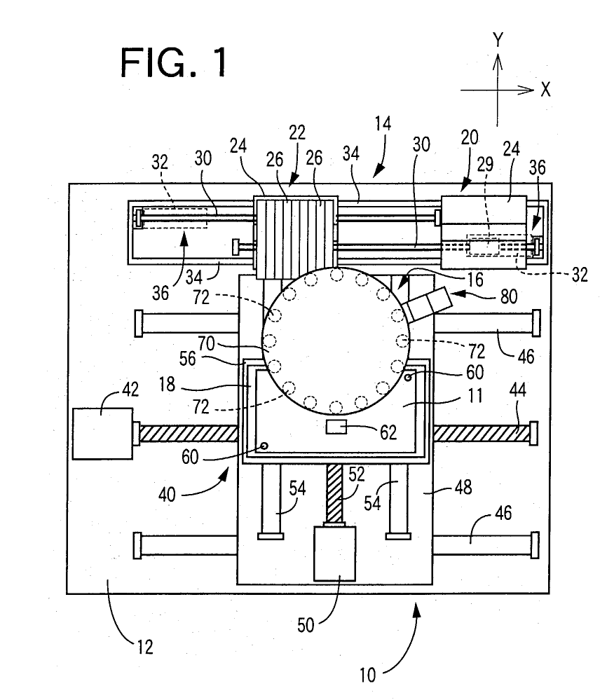

Hereinafter, there will be described an embodiment of the present invention that is applied to an electronic-component mounting apparatus 10. The present electronic-component mounting apparatus 10 mounts electronic components as a sort of electric components on a printed wiring board 11 as a sort of circuit substrate. Since the present apparatus 10 has a construction basically identical with that of an apparatus disclosed in Japanese Patent Application No. 2001-172915, it will be described, below, as needed for understanding the present invention. In FIG. 1, reference numeral 12 designates a base of the present apparatus 10. On the base 12, there are provided a component supplying device 14, a component mounting device 16, and a printed-wiring-board supporting device 18 as a circuit-substrate supporting device all of which cooperate with each other to provide the present electronic-component mounting apparatus 12.

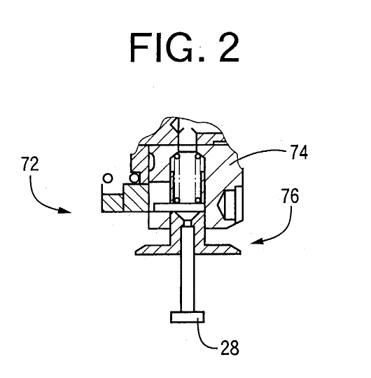

The component supplying device 14 includes at least one component-supply table, more specifically described, in the present embodiment, two component-supply tables 20, 22. Each of the two component-supply tables 20, 22 includes a feeder-supply table 24, and a plurality of feeders 26 that are mounted on the feeder-support table 24. Though the feeders 26 are not illustrated in detail, each feeder 26 feeders a component carrier tape carrying a plurality of electronic components 28 (FIG. 2).

The component carrier tape has a plurality of component accommodating pockets in each of which one electronic component 28 is accommodated. Respective openings of the component accommodating pockets are closed by a cover tape that is adhered to the component carrier tape. The component carrier tape is fed by a tape feeding device (not shown), while the cover tape is peeled off the carrier tape by a tape peeling device, so that the electronic components 28 are fed, one by one, to a component-supply portion of the each feeder 26. The plurality of feeders 26 are detachably attached to the each feeder-support table 24, such that the respective component-supply portions of the feeders 26 are arranged along a line, more specifically, in the present embodiment, a horizontal straight line.

An X-Y coordinate plane is given to the entirety of the present electronic-component mounting apparatus 10. Control data used to move various movable members including the component-supply tables 20, 22 and the wiring-board supporting device 18, are prepared on the X-Y coordinate plane. The straight line along which the respective component-supply portions of the feeders 26 are arranged, is parallel to an X-axis direction (i.e., in a left-and-right direction in FIG. 1) of the X-Y coordinate plane.

A nut 29 is fixed to the feeder-support table 24 of each of the component-supply tables 20, 22 and, when a ball screw 30 as a feed screw is rotated by a support-table drive motor 32, the each component-supply table 20, 22 is moved in the X-axis direction while being guided by a guide device including guide rails 34, so that the component-supply portion of a selected one of the feeders 26 is positioned at a prescribed component-supply position. The two ball screws 30 and the two support-table drive motors 32 cooperate with each other to provide two component-supply-table moving devices 36 that move the two component-supply tables 20, 22, respectively, independent of each other. The two guide rails 34 are commonly used for the two component-supply tables 20, 22, respectively. The two component-supply tables 20, 22 supply the electronic components 28 in such a known manner as disclosed by Japanese Patent Document No. 8-21791. In FIG. 1, the nut 29 for one component-supply table 20 is shown but the feeders therefor are not shown; and the feeders 26 for the other component-supply table 22 are shown but the nut thererfor is not shown.

The wiring-board supporting device 18 supports a printed-wiring board 11 as a sort of circuit substrate, such that the board 11 takes a horizontal posture, and is moved to an arbitrary position on the X-Y coordinate plane by an X-Y table 40 as a circuit-substrate-supporting-device moving device. The X-Y table 40 includes an X-axis slide 48 that is moved in the X-axis direction by an X-axis-slide drive motor 42 and a ball screw 44 as a feed screw while being guided by a guide device including two guide rails 46; and a Y-axis slide 56 that is moved, on the X-axis slide 48, in a Y-axis direction by a Y-axis-slide drive motor 50 and a ball screw 52 as a feed screw while being guided by a guide device including two guide rails 54.

The wiring-board supporting device 18 is provided on the Y-axis slide 56, and supports a lower surface of the printed-wiring board 11 such that the board 11 takes the horizontal position. The printed-wiring board 11 has, on an upper surface thereof, a plurality of prescribed component-mount places or points where respective electronic components 28 are to be mounted and, when the wiring-board supporting device 18 is moved, the component-mount places are sequentially moved to, and positioned at, a position corresponding to a component-mount position where the component mounting device 16 mounts an electronic component 28 at each of the component-mount places on the printed-wiring board 11.

The printed-wiring board 11 has, on its upper surface, a plurality of (in the present embodiment, two) fiducial marks 60, and a fiducial-mark camera 62 as an image taking device takes respective images of the fiducial marks 60 provided on the board 11 supported by the supporting device 18. The camera 62 is supported by a frame, not shown, such that the camera 62 is oriented in a downward direction, so as to take, in the downward direction, the respective images of the fiducial marks 60.

The fiducial-mark camera 62 includes a CCD (charge-coupled device) camera as a sort of solid-state imaging device, and a lens system including an image forming lens, and thus functions as a surface-image taking device that can take at once a two-dimensional image of an object. The CCD camera includes a number of small light receiving elements that are arranged on a plane, and produces respective electric signals corresponding to respective intensities of the respective lights received by the respective light receiving elements. Those light receiving elements cooperate with each other to define an image taking area or surface. An illuminating device, not shown, is provided for the fiducial-mark camera 62, so as to illuminate an object and its background when the camera 62 takes an image of the object.

The component mounting device 16 employed in the present embodiment has a construction identical with that of an electronic-component mounting device disclosed by Japanese Patent Document No. 6-342998, or that of a component mounting device disclosed by Japanese Patent Document No. 2001-345599 or its corresponding U.S. patent application Ser. No. 09/863,431. Hereinafter, the component mounting device 16 will be described briefly. As shown in FIG. 1, the component mounting device 16 includes a disc-like index table 70 that is intermittently rotated, and a plurality of (in the present embodiment, sixteen) holder heads 72 that are supported by the index table 70 such that the holder heads 72 are equiangularly spaced from each other about an axis line of the table 70. As the index table 70 is intermittently rotated, each of the sixteen holder heads 72 is sequentially moved to, and stopped at, each of sixteen stop stations that are provided on a locus of revolution of the heads 72. The stop stations include a component-receive position (i.e., a component-suck position or a component-pick-up position), a component-posture-change position, a component-posture-detect position, a component-posture-correct position, the component-mount position, a head-posture-return position, a holding-portion-detect position, and a holding-portion-select position.

Each of the sixteen holder heads 72 includes, as shown in FIG. 2, a rotary nozzle-hold member 74 having six nozzle-hold portions that hold respective suction nozzles 76. However, only one nozzle-hold portion and only one suction nozzle 76 are shown in the figure. Each holder head 72 selects one of the six suction nozzles 76, and positions the selected suction nozzle 76 at a component-hold position where the selected nozzle 76 is oriented in a vertically downward direction so as to hold an electronic component 28. When the suction nozzle 76 is moved to, and positioned at, the component-receive position so as to receive an electronic component 28 from the component supplying device 14, the holder head 72 and the suction nozzle 76 are moved downward, and a negative pressure is applied to the suction nozzle 76, so that the nozzle 76 sucks and holds the electronic component 28. In addition, when the suction nozzle 76 is moved to, and positioned at, the component-mount position so as to mount the component 28 on the printed-wiring board 11, the nozzle 26 is communicated with a positive-pressure supply source, not shown, so as to release the component 28. The holder heads 72 are provided at a height position where the holder heads 72 holding the respective electronic components 28 are removed without being interfered with by the printed-wiring board 11 and, at the component-receive and component-mount positions, respective elevating and lowering devices are provided so as to elevate and lower each of the heads 72 to respective height positions where the each head 72 can receive and mount an electronic component 28. The holder heads 72 are supported by the index table 70 such that each of the heads 72 is rotatable about an axis line thereof parallel to the axis line of the table 70, and is rotated by a rotating device, not shown, that is provided at, e.g., the component-posture-correct position so as to correct the current posture of the electronic component 28 held by the head 72.

The sixteen holder heads 72 are given respective codes as a sort of identification names that identify those individual heads 72; and the six nozzle-hold portions of each head 72 are given respective codes that identify those individual portions. In addition, data representing each individual nozzle-hold portion are stored in association with data representing a sort of suction nozzle 76 held by the each individual nozzle-hold portion. Thus, based on the above-indicated two sorts of codes and the data representing the sort of suction nozzle 76, the sort of suction nozzle 76 held by the nozzle-hold portion positioned at the component-hold position of each holder head 72 can be identified.

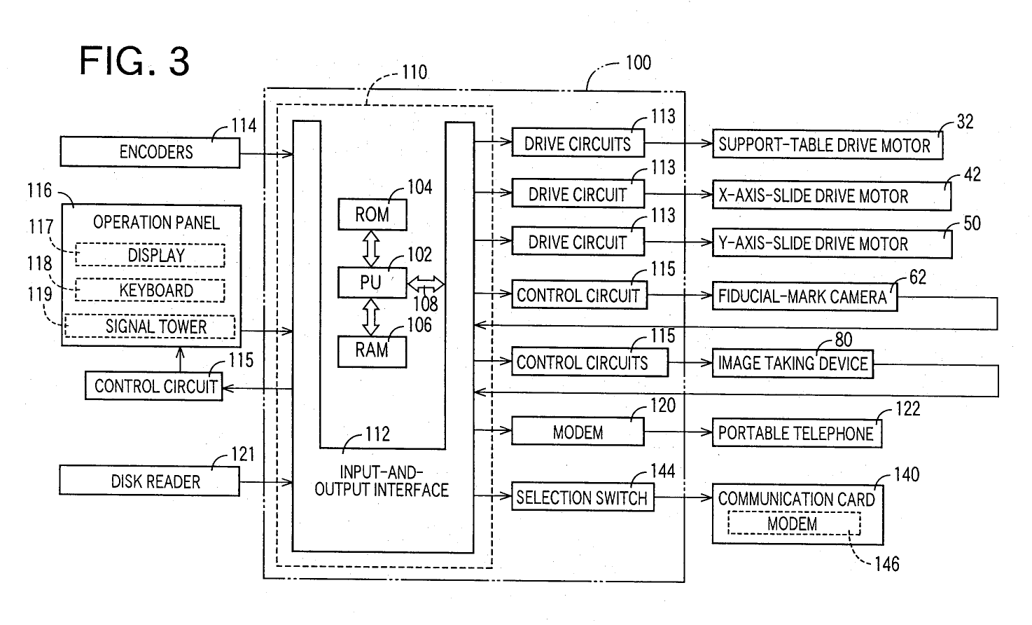

At the component-posture-detect position, there are provided a plurality of (in the present embodiment, two) image taking devices 80 (FIG. 3) each of which includes a component camera, a light guiding device, and an illuminating device. The image taking devices 80 employing the present embodiment have the same construction as that of a component camera disclosed by Japanese Patent Document No. 5-196441.

The electronic-component mounting apparatus 10 constructed as described above is operated under control of a control device 100 shown in FIG. 3. The control device 100 is essentially provided by a computer 110 including a PU (i.e., a processing unit such as a CPU) 102, a ROM (read only memory) 104, a RAM (random access memory) 106, and a bus 108 that couples those elements with each other. The bus 108 is additionally coupled to an input-and-output interface 112 that is connected via respective drive circuits 113 to the above-described drive motors 32, 42, 50. Those drive motors are associated with respective encoders 114 that detect respective rotation angles and transmit the detected rotation angles to the control device 100. Each of the drive motors is provided by a rotary motor as a sort of electric motor (in the present embodiment, a servomotor) that is accurately controllable with respect to rotation angle. Moreover, the input-and-output interface 112 is connected via respective control circuits 115 to the above-described fiducial-mark camera 62 and the image taking devices 80, and is connected via another control circuit 115 to an operation panel 116. The operation panel 116 includes a cathode ray tube 117 as a display device; a keyboard 118 as an input device; and a signal tower 119 as an informing device that informs an operator of a fact that abnormality has occurred to the present apparatus 10. Furthermore, a disk reader 121 that can read data from a magnetic recording medium such as a floppy disk, is connected to the input-and-output interface 112.

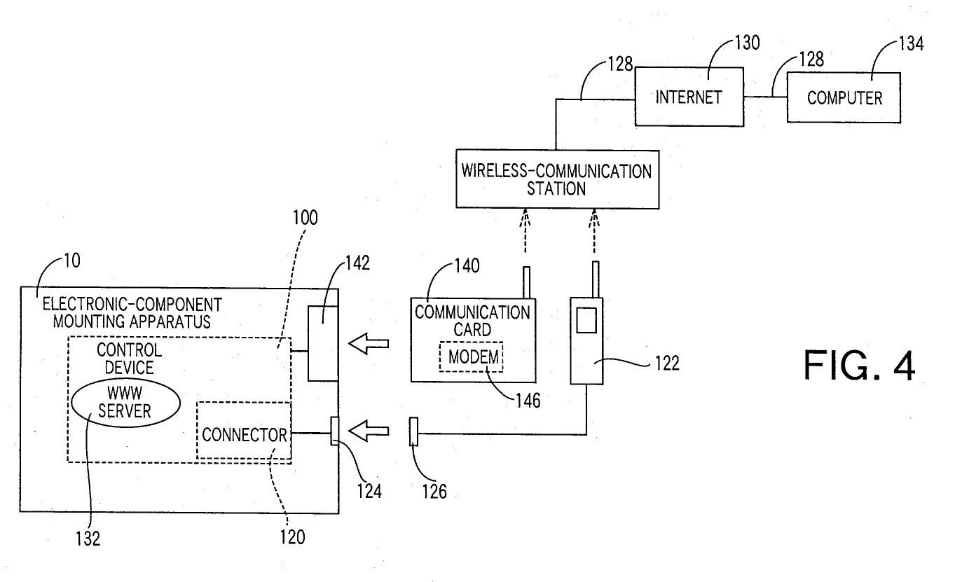

The input-and-output interface 112 is connected to a portable-telephone modem 120 as a communication-terminal interface to which a portable telephone 122 as a communication terminal is disconnectably connected. As shown in FIG. 4, the control device 100 is provided with a connector 124 that connects between the modem 120 and the portable telephone 122. Therefore, if the operator who is operating the present apparatus 10 inserts a connection terminal 126 of the portable telephone 122 into the connector 124 of the control device 100, the telephone 122 is connected to the modem 120, so that the computer 110 is connected via a public communication line 128 to an internet 130. The ROM 104 of the control device 100 stores a WWW server 132 as a communication software that controls a communication operation, so that the control device 100 can transmit, and receive, information related to the apparatus 10 to, and from, another computer 134 that can be connected to the internet 130 via the communication line 128. When the portable telephone 122 is disconnected from the connector 124, the control device 100 is disconnected from the communication line 128 so as to be unable to communicate with the external computer 134. The WWW server 132 may be stored in the RAM 104, or may be stored in the floppy disk and used, as needed, by reading, with the disk reader 121, from the floppy disk.

In the present embodiment, with a communication card 140 being connected to the control device 100, the control device 100 can also be connected to the internet 130. The control device 100 has a slot 142 in which the communication card 140 is inserted to connect the control device 100 to the internet 130. More specifically described, when the communication card 140 is inserted in the slot 142, the control device 100 is connected via the communication line 128 to the internet 130. The communication card 140 is commercially available, has the function of wireless communication with the communication line 128 via a wireless-communication station, and incorporates a modem 146 as an interface that enables the control device 100 to communicate with an external device.

In the present embodiment, the communication card 140 is kept connected with the control device 100, and the control device 100 is provided with a selecting switch 144 that is operable to select a connection position in which the switch 144 connects the communication card 140 to the control device 100 so as to allow communication therebetween, and a disconnection position in which the switch 144 disconnects the card 140 from the control device 100 so as to inhibit the communication. Irrespective of which position the selecting switch 144 may be held in, if the card 140 is removed from the slot 142, the control device 100 is placed in the disconnection position in which the control device 100 is made unable to perform communication. Though the control device 100 can be connected via the internet 130 to the external computer 134, at least the control device 100 is provided with a firewall, not shown, so as to be connectable to a pre-selected computer 134 only.

Next, there will be described an operation of the electronic-component mounting apparatus 10 constructed as described above. Since a mounting operation in which electronic components 28 are mounted on a printed-wiring board 11 is well known in the art, as disclosed by the above-identified Patent Application No. 2001-172915, it will be briefly described below. Various control programs including a main control program, and various control data needed in a mounting operation are stored in the ROM 104 and/or the RAM 106, and/or are recorded in the floppy disk such that the program and/or the data are readable by the disk reader 121. Thus, the mounting operation is carried out according to the programs and the data.

First, a printed-wiring board 11 is carried in by a carry-in device, not shown, and is positioned at a prescribed position where the lower surface of the board 11 is supported by the wiring-board supporting device 18. Next, the board 11 is positioned at a fiducial-mark-image-take position where respective images of the fiducial marks 60 provided on the board 11 are taken by the fiducial-mark taking camera 62. Based on the taken images of the fiducial marks 60, the control device 100 determines positional errors of the board 11 supported by the supporting device 18, i.e., respective parallel-position errors of the board 11 that are caused by the respective movements of the board 11 in the X-axis and Y-axis directions parallel to the upper surface of the board 11, and an angular-position error of the board 11 that is caused by the rotation of the board 11 about a vertical straight line perpendicular to the upper surface of the board 11.

Based on the positional errors of the printed-wiring board 11, the component-mount places prescribed on the board 11, where electronic components 28 are to be mounted, are corrected. The board 11 is positioned relative to the component mounting device 16, such each of the thus corrected component-mount places on the board 11 is positioned right below the component-mount position of the mounting device 16.

Concurrently with the above-described steps, one of the holder heads 72 of the component mounting device 16 receives an electronic component 28 from the component supplying device 14, and is moved, as the index table 70 is rotated, to the component-image-take position where an image of the electronic component 28 held by the head 72 is taken by the image taking device 80. Based on the thus taken image of the electronic component 28, the control device 100 determines positional errors of the component 28, i.e., parallel-position errors and angular-position error of the component 28. When the head 72 holding the component 28 is moved to the component-posture-correct position, the control device 100 rotates the head 28, based on the above-indicated angular-position error, so as to eliminate the error. Because of this rotation to eliminate the error, the respective directions in which the respective parallel-position errors of the component 28 had been determined are changed. After the head 72 is moved to the component-mount position, the head 72 is moved downward so as to place the component 28 on the board 11 and, in this state, the head 72 is communicated with the positive-pressure supply source so as to release the component 28 onto the board 11. To this end, the board 11 is moved in advance to a position that has been corrected to eliminate respective parallel-position errors of the component 28 that had been caused by the rotation of the head 72 to eliminate the angular-position error thereof. Thus, one electronic component 28 is mounted on the printed-wiring board 11.

The present electronic-component mounting apparatus 10 is connectable to the internet 130, so as to communicate with the external computer 134, irrespective of whether the apparatus 10 is currently carrying out an electronic-component mounting operation. When the operator connects the portable telephone 122 to the connector 124, or operates the selecting switch 144 associated with the communication card 140, to the connection (“ON”) position thereof, the control device 100 is connected to the public communication line 128. If the control device 100 is connected via the communication line 128 to the internet 130, another computer 134 is connectable via the internet 130 to the control device, so that the computer 134 and the control device 100 can transmit and receive information related to the apparatus 10 to and from each other.

The information related to the apparatus 10 is, e.g., a current condition of the apparatus 10, for example, a screen image that is displayed by the display device 117 of the operation panel 116. The screen image includes indications related to the current condition of the apparatus 10, such as an indication of stopping of the apparatus 10 that is caused by malfunction of the apparatus 10; an indication of consumption of electronic components 28; details of the stopping of apparatus 10 or the consumption of components 28; or a degree of progress of operation, and additionally includes indications related to requests and instructions directed to the operator, such as requests directed to the operator to do certain operations or treatments.

In addition, the control device 100 can receive operation-command information to command the apparatus 10 to carry out certain operations. The operation-command information includes some commands that can be inputted through the operation panel 116, such as a check command to command the apparatus 10 to check itself; or an exchange command to command the apparatus 10 to automatically exchange parts, such as suction nozzles 76. Thus, the operator can operate the present apparatus 10, as if the operator directly operated the operation panel 116 provided in the vicinity of the apparatus 10. However, during an automatic operation of the apparatus 10, the apparatus 10 cannot receive the operation-command information, in order to prevent the automatic operation from being interfered with by an operation commanded by the operation-command information.

In addition, the present electronic-component mounting apparatus 10 can receive information related to the various control programs including the main control program, and other sorts of information needed to carry out a mounting operation. For example, the apparatus 10 can receive information needed to update the current control programs, or even new control programs.

Thus, a service person who belongs to a manufacturer or a dealer can connect the external computer 134 to the control device 100 via the internet 130 and can perform various services such as checking of the apparatus 10, shooting of troubles, or updating of the software, without going to the place where the apparatus 10 is disposed. Since the portable telephone 122 and the communication card 140 function as a communication terminal, in a substantially same way, the following description is directed to the case where the portable telephone 122 is used to connect the control device 100 to the internet 130.

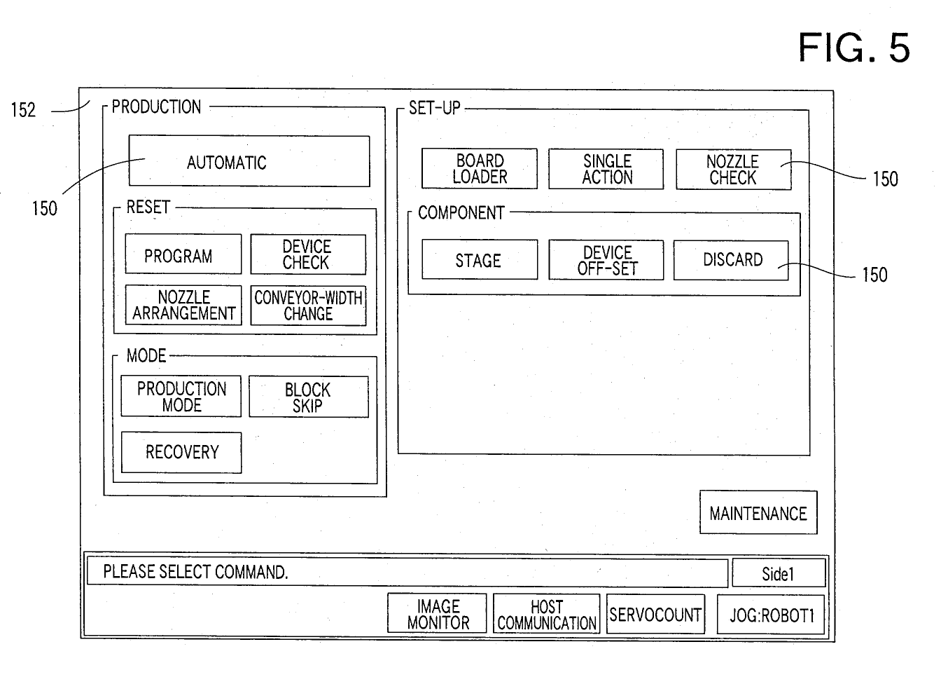

The above-indicated services are performed in substantially the same manners as disclosed in Japanese Patent Application No. 2001-302630. More specifically described, when the external computer 134 is connected to the control device 100 via the internet 130, the control device 100 transmits information representing the screen image of the display device 117, to the computer 134, so that a display device of the computer 134 displays the same screen image as the screen image currently displayed by the display device 117, as shown in FIG. 5. Though the display device 117 can display various screen images, one of those screen images that is shown in the figure is a command-input image 152 including a plurality of command-input pads 150 as respective command inputting devices that are operable for inputting corresponding commands. In the present embodiment, the service person can input various commands by selecting appropriate ones of the command pads 150 in the command-input image 152 displayed by the display device of the computer 134, as if the person did by selecting the pads 150 displayed by the display device 117 of the operation panel 116. Thus, the service person can instruct, by operating the computer 134, the apparatus 10 to perform various commands inputted by the person, without going to the place where the apparatus 10 is disposed. In this way, the above-indicated various services are achieved. Hereinafter, there will be described the three services, i.e., the checking service, the trouble shooting service, and the software updating service will be described in the order of description.

First, the checking service is explained. In the present embodiment, the checking of the electronic-component mounting apparatus 10 is periodically carried out. More specifically described, when a number of printed-wiring boards 11 used to produce respective electric-circuit boards, or a time (e.g., hours) of operation of the apparatus 10 exceeds a prescribed value, the apparatus is checked in such a manner that the checking does not interfere with the electronic-component mounting operation.

When the control device 100 judges that the checking of the apparatus 10 should be carried out, first, the control device 100 operates the display device 117 of the operation panel 116 to display a message requesting the operator to connect the portable telephone 122 to the control device 100. According to the message, the operator connects the telephone 122 to the control device 100. Thus, the control device 100 is placed in a state in which the control device 100 can transmit the information stored therein, to the internet 130. Next, the operator communicates with the service person via an appropriate medium such as telephone, so as to request the person to perform the checking of the apparatus 10, and inform the person of the fact that the control device 100 is currently connected to the internet 130. According to the operator's request, the service person connects the computer 134 to the internet 130. If the computer 134 is connected via the internet 130 to the control device 100, the same screen image as the screen image currently displayed by the display device 117 of the operation panel 116 is displayed on the display device of the computer 134. Thus, the service person selects appropriate ones of the command-input pads 150 displayed on the display device of the computer 134, so that respective sets of information related to respective items corresponding to the selected pads 150 are displayed on the display device.

Based on those sets of information displayed on the display device of the computer 134, the service person can check the electronic-component mounting apparatus 10. For example, the person can recognize a current condition of the apparatus 10 based on the current sets of information and the past sets of information.

If an abnormality of the apparatus 10 is found as a result of checking, the service person can estimate the cause of the abnormality before the operation of the apparatus 10 is stopped because of its malfunction. Since the service to remove the cause of abnormality is the same as the trouble-shooting service, described bellow.

Next, the trouble-shooting service will be described. For example, there are some cases where during an automatic operation of the present apparatus 10, a serious malfunction occurs and the operation of the apparatus 10 is automatically stopped. If the trouble of the apparatus 10 cannot be treated by the operator or other persons in charge of the apparatus 10, then the operator communicates with the service person via an appropriate medium such as telephone, so as to request the service person to treat or shoot the trouble of the apparatus 10. In addition, the operator connects the portable telephone 122 to the control device 100.

Like the above-described checking service, since the control device 100 and the computer 134 are connected to each other via the internet 130, first, a screen image currently displayed on the display device 117 of the operation panel 116 is also displayed on the display device of the computer 134. In the present embodiment, when a trouble occurs to the apparatus 10, the display device displays a screen image including a code as an identifier that identifies a sort of the trouble and estimated causes of the trouble, and a message related to countermeasures against the trouble. Based on the screen image, the service person can recognize the current condition of the apparatus 10 and, if the person needs a greater amount of information, the person selects appropriate command-input pads 150 so as to command the display device to display the information needed and, based on the thus obtained information, determine countermeasures against the trouble. If the thus determined countermeasures are, e.g., supplying of electronic components 28 or replacing of simple parts and accordingly can be done by the operator in the factory, the service person instructs the operator to treat the trouble. Alternatively, if the service person can input appropriate instructions into the computer 134 and thereby treat the trouble, the person can do that. However, in the case where the trouble cannot be treated without the service person who can make direct access to the apparatus 10, the person goes to the factory to treat the trouble of the apparatus 10. Thus, the frequency at which the service person goes to the factory is reduced.

Next, the service of updating the software stored in the control device 100 will be explained below. When the service person wants to add new software to the current software stored in the control device 100 or updating the current software, the person first confirms that the portable telephone 122 is currently connected to the control device 100 and subsequently transmits information from the computer 134 to the control device 100. If the control device 100 responds to the computer 134 when the computer 134 tries to communicate with the control device 100 via the internet 130, then the computer 134 transmits the information to the control device 100. On the other hand, if the control device 100 does not respond, that is, if the display device of the computer 134 does not display the screen image displayed by the display device 117 of the operation panel 116, the service person requests the operator in the factory to connect the portable telephone 122 to the control device 100. After the service person confirms that the computer 134 and the control device 100 are connected to each other via the internet 130, the person transmits information from the computer 134 to the control device 100.

However, it is recommended that during the automatic operation of the electronic-component mounting apparatus 10, the software updating service be not carried out and that if the control device 100 receives information during the automatic operation, then the control device 100 refrain from writing the information till the automatic operation is ended.

It emerges from the foregoing description of the illustrated embodiment that each of the portable-telephone modem 120 and the modem 146 provides a communication-terminal interface.

In the illustrated embodiment, the control device 100 and the computer 134 are connected to each other via the internet 130. However, the control device 100 and the computer 134 may be connected to each other in a different manner, e.g., directly connected to each other via the communication line 128 with the help of software for communication between personal computers. In the latter case, it is not essentially needed to employ the firewall.

The illustrated electronic-component mounting apparatus 10 has both the connector 124 to which the portable telephone 122 is connectable, and the slot 142 in which the communication card 140 is insertable, and each of the connector 124 and the slot 142 is usable for communication. However, the present apparatus 10 may be modified to have only one of the connector 124 and the slot 142. In addition, a communication terminal such as the portable telephone 122 or the communication card 140 may not be exclusive for the present apparatus 10. For example, a portable telephone owned by the operator may be connected to the control device 100, as needed.

Moreover, the control device 100 of the electronic-component mounting apparatus 10 may be used with a communication terminal 204 including a modem 200 as a communication-terminal interface, and a memory 202 in which a communication software such as WWW server 132 is stored.

The foregoing description relates to the “index-tabletype” electronic-component mounting apparatus 10. However, the present invention is applicable to an “X-Y-robot-type” electronic-component mounting apparatus including a holder head 72 that holds an electronic component 28, and an X-Y robot that supports the holder head 72 and moves the head 72 in a horizontal plane so that the head 72 mounts the electronic component 28 on a printed-wiring board 11 that is supported such that the board 11 is not movable.

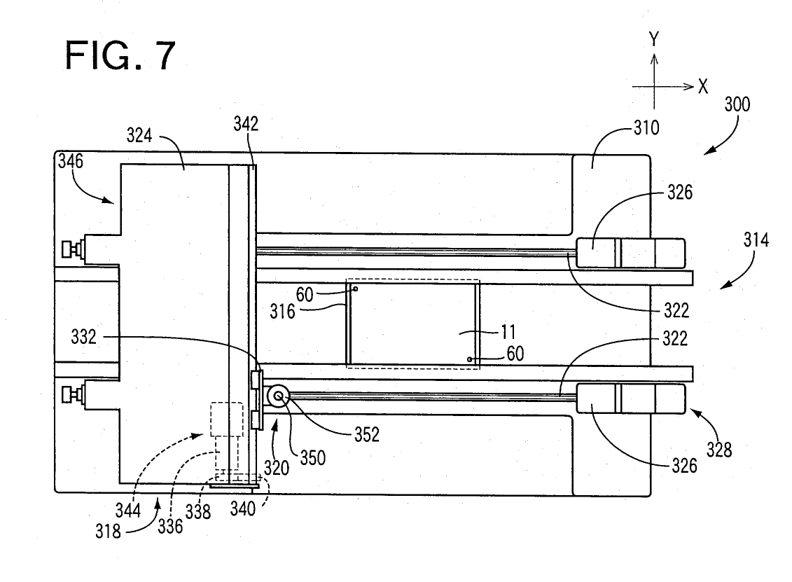

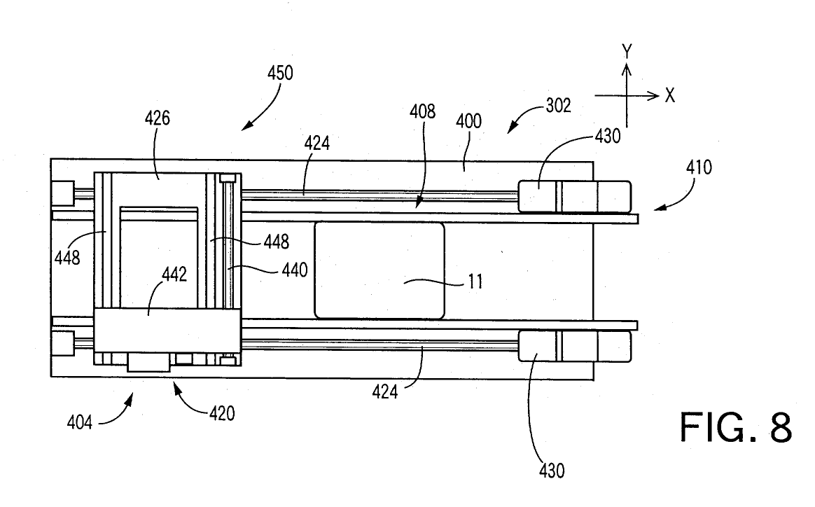

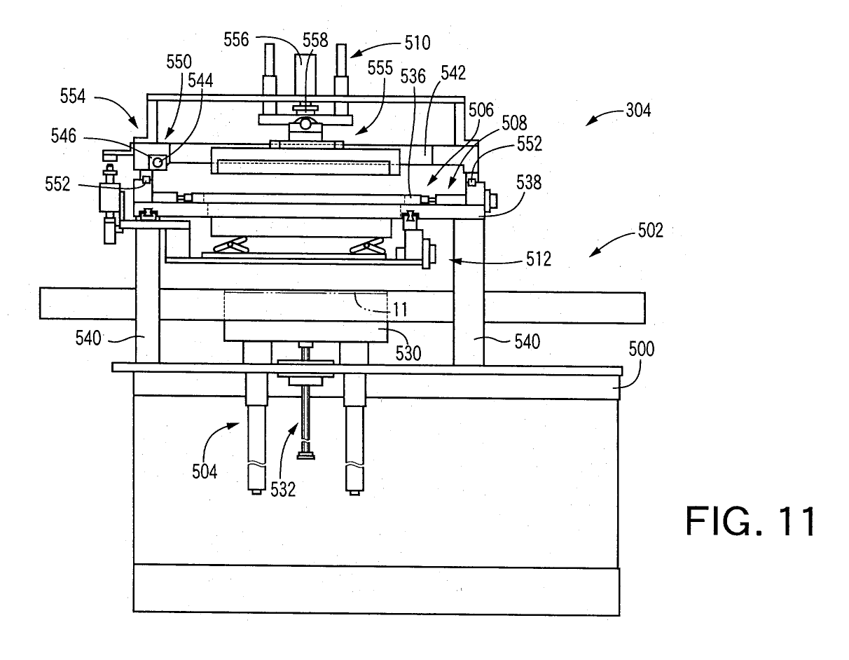

In addition, the present invention is applicable to other sorts of production apparatuses than the electronic-component mounting apparatus 10. For example, the present invention is applicable to a wiring-board inspecting apparatus 300 (FIG. 7) that inspects a printed-wiring board 11 on which electronic components 28 have been mounted; an adhesive applying apparatus 302 (FIG. 8) as a high-viscosity-fluid applying apparatus; a mask-printing apparatus 304 that prints a printing material such as cream solder, on a printed-wiring board 11; or other sorts of production apparatuses. Hereinafter, those apparatuses 300, 302, 304 will be described by reference to FIGS. 7 through 12.

FIG. 7 shows the wiring-board inspecting apparatus 300 including a base 310 on which there are provided a wiring-board conveyor 314, a wiring-board supporting device 316, and an inspecting apparatus 318. The wiring-board conveyor 314 conveys a printed-wiring board 11 in an X-axis direction (i.e., in a left-and-right direction in FIG. 7); the wiring-board supporting device 316 supports the printed-wiring board 11; and the inspecting apparatus 318 takes an image of an upper surface of the board 11 and inspects the upper surface based on the taken image theref.

In the present embodiment, the printed-wiring board 11 is conveyed by the wiring-board conveyor 314 such that the board 11 takes a horizontal posture, and is stopped at a prescribed operation position by a stopping device, not shown. At the prescribed operation position, the printed-wiring board 11 is supported by the wiring-board supporting device 316 provided on a portion of the base 310 that corresponds to the prescribed operation position. In the present embodiment, the board 11 is supported by the supporting device 316 such that an upper surface of the board 11 that is to be inspected takes a horizontal posture.

The inspecting device 318 includes an image taking device 320 that takes an image of the upper surface of the printed-wiring board 11, and moves the image taking device 320 in each of X-axis and Y-axis directions perpendicular to each other so that the image taking device 320 takes an image of the upper surface of the board 11. To this end, two ball screws 322 each extending in the X-axis direction are provided, on the base 310, on opposite sides of the wiring-board conveyor 314 in the Y-axis direction, respectively, and are threadedly engaged with respective nuts, not shown, provided on an X-axis slide 324. When the two ball screws 322 are rotated by respective X-axis-slide drive motors 326, the X-axis slide 324 is moved to an arbitrary position in the X-axis direction. The nuts, the ball screws 322 and the X-axis-slide drive motors 326 cooperate with each other to provide an X-axis-slide moving device 328.

On the X-axis slide 324, there is provided a ball screw, not shown, that extends in the Y-axis direction and is threadedly engaged with a nut, not shown, fixed to a Y-axis slide 332. When the ball screw is rotated by a Y-axis-slide drive motor 336 via gears 338, 340, the Y-axis slide 332 is moved to an arbitrary position in the Y-axis direction while being guided by a guide rail 342 as a guide member. The nuts, the ball screw and the Y-axis-slide drive motor 336 cooperate with each other to provide a Y-axis-slide moving device 344 that cooperates with the X-axis slide 324, the X-axis-slide moving device 328, and the Y-axis slide 332 to provide an X-Y moving device 346 as a sort of displacing device that displaces the image taking device 320 relative to the printed-wiring board 11.

The image taking device 320 is supported by the Y-axis slide 332 such that the image taking device 320 is not movable relative to the slide 332. The image taking device 320 includes an inspection camera 350 and an illuminating device 352 associated therewith. In the present embodiment, the inspection camera 350 is provided by a CCD camera as a surface-image taking device. The illuminating device 352 illuminates a each portion of the upper surface of the printed-wiring board 11 whose image is to be taken, and a portion surrounding the each portion.

The present wiring-board inspecting apparatus 300 is operated under control of a control device that is essentially provided by a computer. This control device is substantially identical with the above-described control device 100, and can transmit, and receive, a result of inspection of the printed-wiring board 11 and information related to the apparatus 300, to, and from, an external computer 134.

Next, the adhesive applying apparatus 302 will be described. The present adhesive applying apparatus 302 has a construction substantially identical with that of an adhesive applying apparatus disclosed by Japanese Patent Document No. 2002-139452.

FIG. 8 shows the adhesive applying apparatus 302 including a base 400 on which there are provided an applying device 404 and a wiring-board supporting and conveying device 408 as an object supporting and conveying device that supports, conveys, and positions a printed-wiring board 11 as an object to which an adhesive is to be applied. The wiring-board supporting and conveying device 408 includes a wiring-board conveyor 410 extending in an X-axis direction (i.e., a left-and-right direction in FIG. 8); and a wiring-board supporting device, not shown, and a wiring-board clamping device, not shown, that are provided below an intermediate portion of the wiring-board conveyor 410. The printed-wiring board 11 is conveyed by the wiring-board conveyor 410, and is positioned at a prescribed application position where the board 11 is supported by the wiring-board supporting device, and is clamped by the wiring-board clamping device. In this state, an adhesive as a high-viscosity fluid is applied to the board 11.

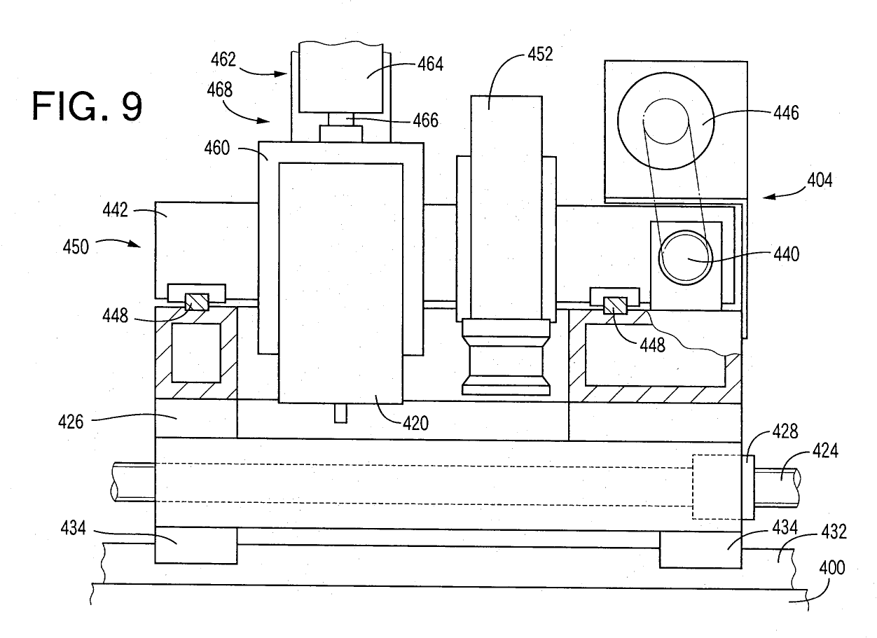

The applying device 404 includes an applying unit 420 that is linearly moved in each of X-axis and Y-axis directions perpendicular to each other so as to apply an adhesive to an upper surface of the printed-wiring board 11 on which electronic components 28 are to be mounted. To this end, two ball screws 424 as feed screws that extend in the X-axis direction are provided, on the base 400, on opposite sides of the wiring-board conveyor 410 in the Y-axis direction, respectively, and are threadedly engaged with respective nuts 428 (FIG. 9) fixed to an X-axis slide 426. When the two ball screws 424 are rotated by two X-axis-direction drive motors 430 (FIG. 8), respectively, the X-axis slide 426 is moved in the X-axis direction. On the base 400, two guide rails 432 as guide members are provided below the two balls screws 424, respectively, as shown in FIG. 9. The X-axis slide 426 fits on the two guide rails 432 via respective guide blocks 434 as guided members, such that the slide 426 is slideable on the rails 432. Thus, the movement of the X-axis slide 426 in the X-axis direction is guided by the guide rails 432.

As shown in FIGS. 8 and 9, the X-axis slide 426 supports a ball screw 440 as a feed screw such that the ball screw 440 extends in the Y-axis direction, is rotatable about an axis line thereof, and is not movable in an axial direction thereof. A Y-axis slide 442 is threadedly engaged with the ball screw 440 via a nut, not shown, fixed to the slide 442. When the ball screw 440 is rotated by a Y-axis-slide drive motor 446 (FIG. 9), the Y-axis slide 442 is moved in the Y-axis direction while being guided by a pair of guide rails 448 as guide members. Thus, the nuts 428, the ball screws 424, the X-axis slide 426, the X-axis-slide drive motors 430, the nut, the ball screw 440, the Y-axis slide 442, the Y-axis-slide drive motor 446 cooperate with each other to provide an X-Y robot 450. In the present embodiment, the printed-wiring board 11 is supported by the wiring-board supporting device such that the board 11 takes a horizontal posture and the upper surface of the board 11 is kept horizontal; and the applying unit 420 is moved by the X-Y robot 450 to an arbitrary position in a horizontal plane parallel to the upper surface of the board 11.

The Y-axis slide 442 supports a fiducial-mark-image taking device 452 that takes respective images of fiducial marks 60 provided on the printed-wiring board 11, such that the image taking device 452 is oriented in a vertically downward direction. The image taking device 452 is not movable relative to the Y-axis slide 442, and is moved as a unit integral with the applying unit 420 in a horizontal plane.

Next, the applying unit 420 will be described. The applying unit 420 is moved downward, and upward, on the Y-axis slide 442, so as to be moved toward, and away from, the printed-wiring board 11. To this end, the Y-axis slide 442 supports a pair of guide rails, not shown, as guide members that extend in a vertical direction, and a Z-axis slide 460 fits on the guide rails via respective guide blocks, not shown, such that the slide 460 is slideable on the guide rails and is moved upward and downward in a Z-axis direction by a Z-axis-slide drive device 462. In the present embodiment, the Z-axis-slide drive device 462 includes, as a drive source thereof, an air-operated cylinder device 464 as a sort of pressurized-fluid-operated cylinder device as a sort of pressurized-fluid-operated actuator. The air-operated cylinder device 464 includes a piston rod 466 connected to the Z-axis slide 460. When the piston rod 466 is extended and retracted, the Z-axis slide 466 is moved downward and upward, respectively, so that the applying unit 420 provided on the Z-axis slide 460 is moved in a direction perpendicular to the upper surface of the printed-wiring board 11. In the present embodiment, the air cylinder 464 has a restricting device that restricts an amount of air flowing from an air chamber in a state in which a piston of the cylinder is moved to around the end of stroke of the piston. Thus, the Z-axis slide 460 is smoothly decelerated and is stopped without shock. The Z-axis slide 460 and the Z-axis-slide drive device 462 cooperate with each other to provide an applying-unit elevating and lowering device 468 that moves the applying unit 420 relative to the object 11 in the directions perpendicular to the upper surface of the object. The applying-unit elevating and lowering device 468 also functions as an applying-nozzle elevating and lowering device that elevates and lowers an applying nozzle as an element of the applying unit 420. In the present embodiment, the Z-axis slide 460 provides a main frame of the applying device 404; and the X-Y robot 450 and the Z-axis-slide drive device 462 cooperate with each other to provide a moving device that moves the Z-axis slide 460 relative to the printed-wiring board 11 in the directions parallel to, and the directions perpendicular to, the upper surface of the board 11. However, the applying-unit elevating and lowering device 468 may be modified such that the device 468 employs, as the drive source thereof, a servomotor as a sort of electric motor that can move the applying unit 420 to an arbitrary position in the Z-axis direction perpendicular to the X-axis and Y-axis directions.

The applying unit 420 includes an applying nozzle; a nozzle rotating device; a screw pump; a screw rotating device; and an adhesive supplying device as a sort of high-viscosity-fluid supplying device as a sort of application-material supplying device. The applying nozzle has the same construction as that of an applying nozzle disclosed by the above-indicated Japanese Patent Document No. 2002-139452 and applies an adhesive to a printed-wiring board 11 in the same manner as that disclosed by the Japanese Patent Document.

The present adhesive applying apparatus 302 is operated under control of a control device that has a construction identical with that of the above-described control device 100 and can transmit, and receive, information related to the apparatus 302, to and from an external computer 134.

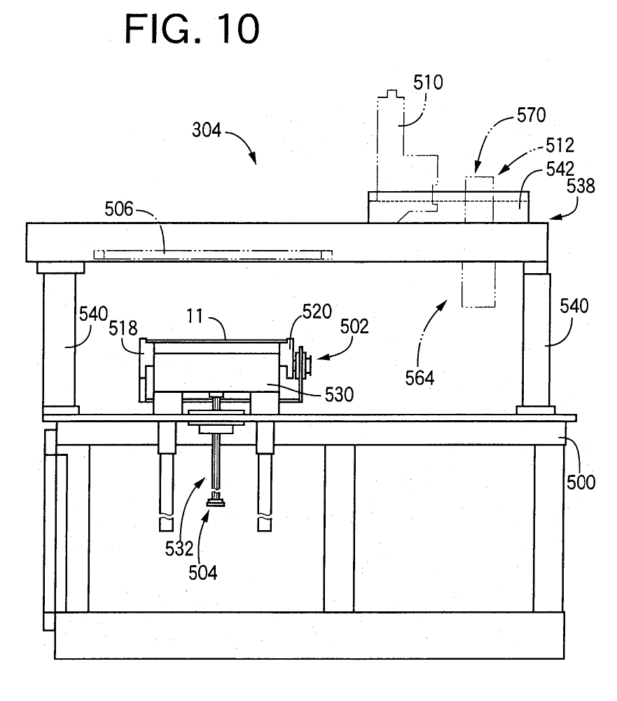

FIGS. 10, 11, and 12 show the mask-printing apparatus 304. The mask-printing apparatus 304 has a construction substantially identical with that of a mask-printing apparatus disclosed by Japanese Patent Document No. 2001-116528.

In FIG. 10, reference numeral 500 designates a base on which there are provided a wiring-board conveyor 502; a wiring-board supporting, elevating, and lowering device 504; a wiring-board hold-down device, not shown; a mask positioning and supporting device 508; a printing device 510; and a mask cleaning device 512. The wiring-board conveyor 502 functions as a conveying device that conveys a printed-wiring board 11 as an object; the wiring-board supporting, elevating, and lowering device 504 functions as an object supporting, elevating, and lowering device as a sort of an object supporting device, and supports, elevates and lowers the board 11 conveyed by the conveyor 502; the wiring-board hold-down device holds down the board 11 when the wiring-board supporting, elevating, and lowering device 504 supports the board 11; the mask-printing device 508 positions and supports a mask plate 506; and the mask cleaning device 512 cleans a mask 534 supported by the mask plate 506.

The wiring-board conveyor 502 includes a pair of rails 518, 520, and a pair of endless belts, not shown, as wound-on members that are wound on the rails 518, 520, respectively. The printed-wiring board 11 is placed on the two endless belts. When the two belts are circulated by a belt drive device, not shown, the board 11 is conveyed. A distance between the two rails 518, 520 can be adjusted or changed according to a dimension or width of the board 11. The printed-wiring board 11 conveyed by the conveyor 502 is stopped by a stopping device, not shown, at a prescribed printing position where cream solder is to be printed on the board 11.

The wiring-board supporting, elevating, and lowering device 504 is provided below the printing device 510, and includes a wiring-board support table 530 as an object support table that is movable upward and downward through a space present between the two rails 518, 520. In the present embodiment, the wiring-board support table 530 applies a negative pressure to the printed-wiring board 11 to suck the board 11, and supports the board 11 such that the board 11 takes a horizontal posture. An elevating and lowing device 532 elevates the support table 530 to an upper dead position thereof where the board 11 supported by the table 530 is lifted off the belts of the wiring-board conveyor 502 and contacts a lower surface of the mask 534 of the mask plate 506, and lowers the table 530 to a lower dead position thereof where the table 530 is positioned below the conveyor 502.

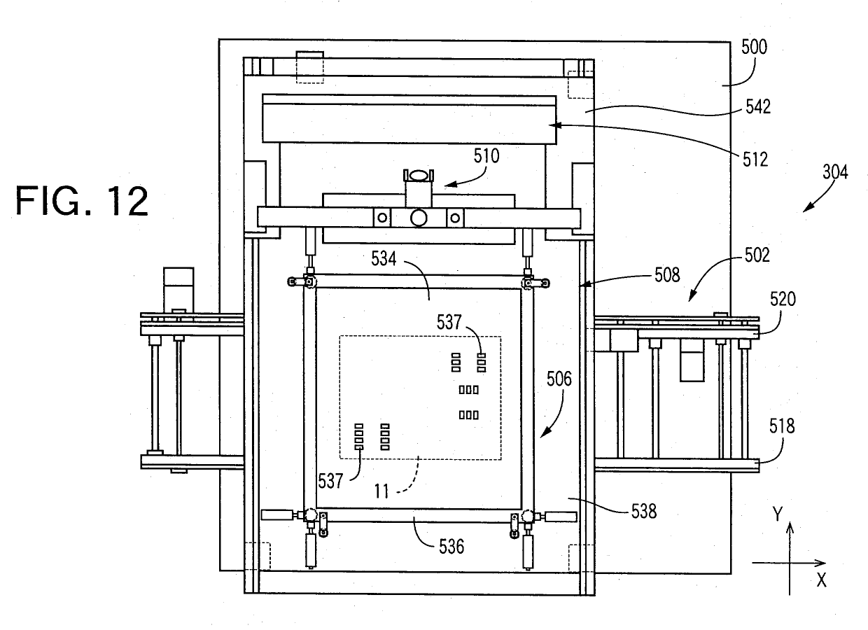

As shown in FIG. 12, the mask plate 506 includes, in addition to the mask 534, a mask frame 536 to a lower surface of which a peripheral portion of the mask 534 is fixed. In the present embodiment, the mask 534 is a stencil mask that is formed of, e.g., a nickel alloy or a stainless steel. The mask 534 has a plurality of apertures 537 that are formed through the thickness of the mask 534. In the present embodiment, each of the apertures 537 has a rectangular (e.g., square) cross section as seen in the plan view of the mask 534. The printed-wiring board 11 has, on a planar upper surface thereof, a plurality of printing spots where cream solder is to be printed, and the mask 534 has respective apertures 537 at respective positions corresponding to the printing spots on the board 11. In the present embodiment, one pair of opposed sides of the rectangular cross section of each of the apertures 537 are parallel to the X-axis direction, and the other pair of opposed sides of the rectangular cross section are parallel to the Y-axis direction.

Four columns 540 stand on the base 500, and a mask-support table 538 that supports the mask plate 506 is fixed to those columns 540. The mask plate 506 is supported by the mask-support table 538 via the above-described mask positioning and supporting device 508, such that respective positions of the mask plate 506 in the X-axis and Y-axis directions are adjustable.

Next, the printing device 510 will be described. The printing device 510 has a construction identical with that of a mask-printing device disclosed by Japanese Patent Document No. 9-39214. On the mask-support table 538, there is provided a slide 542 that is movable in a direction perpendicular to a wiring-board conveying direction, i.e., a substrate conveying direction. The slide 542 is moved in a printing direction, i.e., the Y-axis direction perpendicular to the wiring-board conveying direction, while being guided by guide rails 552. The slide 542 is moved by a drive device 550 including a ball screw 544 that is supported by the mask-support table 538 such that the ball screw 544 is rotatable about an axis line thereof and is not movable in an axial direction thereof a nut 546 that is fixed to the slide 542 and is threadedly engaged with the ball screw 544; and a printing-head moving servomotor, not shown. The slide 542 and the drive device 550 cooperate with each other to provide a printing-head moving device 554; and the two guide rails 552 provide a guiding device.

A printing head 555 is moved upward and downward by a printing-head elevating and lowering air-operated cylinder device 556 as a printing-head elevating and lowering device that is provided on the slide 542. The printing head 555 is attached to the air cylinder 556 via a contact-load adjusting air-operated cylinder device 558 and a load sensor, not shown. Based on a contact load detected by the load sensor, the contact-load adjusting air cylinder 558 is operated by a control device so that the printing head 555 contacts the mask 534 with a prescribed load.

The printing head 555 accommodates, in a solder chamber thereof, cream solder as a printing material, and pushes, with a prescribed pressure, the cream solder through an elongate outlet thereof that is opposed to an upper surface of the mask 534 and extends in a widthwise direction of the head 555. The printing head 555 is moved on the mask 534 while pushing out the cream solder in the state in which the outlet of the head 555 is held in contact with the upper surface of the mask 534. Consequently the cream solder is squeezed into the apertures 537 of the mask 534, so that the cream solder is printed on the printed-wiring board 11. The pushing pressure with which the cream solder is pushed out of the solder chamber of the head 555 is monitored by a pushing-pressure sensor, not shown.

The printing device 510 further includes the mask cleaning device 512. The mask cleaning device 512 removes, by washing or wiping, the cream solder adhered to the lower surface of the mask 534, i.e., the contact surface of the mask 534 that contacts the printed-wiring board 11, and the cream solder clogging the apertures 537 of the mask 534.

The present mask-printing apparatus 304 is operated under control of a control device having a construction identical with that of the above-described control device 100, and can transmit, and receive, information related to the apparatus 304, to, and from, an external computer 134.

While the present invention has been described in detail in its embodiments, it is to be understood that the present invention is not limited to the details of those embodiments and may be embodied with various changes and improvements, such as those described in SUMMARY OF THE INVENTION, which may occur to a person skilled in the art.

What is claimed is:

1. A production apparatus comprising:
an operating device;
a control device which controls an operation of the operating device;
a communication-terminal interface through which the control device is connectable to a communication terminal; and
a memory in which a communication software needed for communication between the control device and the communication terminal through the communication-terminal interface is stored.

2. A production apparatus comprising:
an operating device;
a control device which controls an operation of the operating device;
a connectable portion which is connectable to a communication terminal incorporating a communication-terminal interface; and
a memory in which a communication software needed for communication between the control device and the communication terminal through the communication-terminal interface is stored.

3. A production apparatus comprising:
at least one operating device;
a control device which controls an operation of said at least one operating device;
a communication-terminal interface;
a communication terminal which is connectable to the control device through the communication-terminal interface; and
a memory in which a communication software needed for communication between the control device and the communication terminal through the communication-terminal interface is stored.

4. An apparatus according to claim 3, wherein the communication-terminal interface is in a fixed state in which the interface is connected to the control device, and the communication terminal is disconnectably connected to the interface.

5. An apparatus according to claim 3, wherein the communication terminal comprises a portable telephone.

6. An apparatus according to claim 3, wherein the communication terminal comprises a communication card.

7. An apparatus according to claim 3, wherein the control device comprises a switch which is selectively operable to a communication permitting position in which the control device is permitted to perform communication via the communication terminal, and a communication inhibiting position in which the control device is inhibited from performing communication.

8. An apparatus according to claim 3, wherein the communication software comprises an operation-related-information transmitting step of transmitting operation-related information that is related to the operation of said at least one operating device.

9. An apparatus according to claim 8, wherein the operation-related information comprises a rate of operation of said at least one operating device.

10. An apparatus according to claim 8, further comprising a display device which displays information representing at least one operating condition of said at least one operating device, and the operation-related information comprises the information displayed by the display device.

11. An apparatus according to claim 3, wherein the communication software comprises an information receiving step of receiving information which is supplied via a public communication line.

12. An apparatus according to claim 11, further comprising a display device which displays each one of a plurality of images representing a plurality of operating conditions of said at least one operating device, and the information receiving step comprises an image-change-command receiving step of receiving an image-change command to command the display device to change said each one of the images to another image.

13. An apparatus according to claim 11, wherein the information receiving step comprises a remote-control-signal receiving step of receiving a remote-control signal for remote control of the apparatus.

14. An apparatus according to claim 3, comprising an operation-on-circuit-substrate performing apparatus, wherein said at least one operating device comprises an operation-on-circuit-substrate performing device which performs an operation on a circuit substrate.

15. An apparatus according to claim 14, comprising an electric-component mounting apparatus, wherein the operation-on-circuit-substrate performing device comprises an electric-component mounting device which mounts at least one electric component on the circuit substrate.

16. An apparatus according to claim 14, comprising a screen-printing apparatus, wherein the operation-on-circuit-substrate performing device comprises a screen-printing device which screen-prints a high-viscosity fluid, such as a cream solder, on the circuit substrate.

17. An apparatus according to claim 14, comprising a high-viscosity-fluid applying apparatus, wherein the operation-on-circuit-substrate performing device comprises a high-viscosity-fluid applying device which applies a high-viscosity fluid in form of spots to the circuit substrate.

18. An apparatus according to claim 3, wherein the control device comprises a control computer which controls the operation of the operating device.

19. An apparatus according to claim 18, further comprising a host computer which is connected to the control computer and supplies, to the control computer, information needed to control the operation of the operating device.

20. An apparatus according to claim 19, wherein the communication-terminal interface is connected to the host computer.

21. A communication method comprising the steps of:
connecting a production apparatus including an operating device and a control device which controls the operating device, to a public communication line via a communication terminal,
transmitting, and receiving, information related to the production apparatus, to, and from, the public communication line via the communication terminal, respectively, and
authorizing an operator of the production apparatus to permit communication between the production apparatus and the public communication line via the communication terminal.
